(19) United States
(12) Patent Application Publication
(10) Pub. No.: US 2013/0226501 A1
(43) Pub. Date: Aug. 29, 2013

(54) SYSTEMS AND METHODS FOR PREDICTING ABNORMAL TEMPERATURE OF A SERVER ROOM USING HIDDEN MARKOV MODEL

(71) Applicant: Animikh Ghosh, Kolkata (IN)

(72) Inventor: Animikh Ghosh, Kolkata (IN)

(73) Assignee: Infosys Limited, Bangalore (IN)

(21) Appl. No.: 13/526,998

(22) Filed: Jun. 19, 2012

(30) Foreign Application Priority Data
Feb. 23, 2012 (IN) 671/CHE/2012

(51) Int. Cl. G01K 13/00; G06F 15/00

(52) U.S. Cl. 702/130

(57) ABSTRACT

The invention relates to a system and method for predicting abnormal temperature of a server room using Hidden Markov model. This invention involves capturing the real temperature value at a given point of time through sensors and determining that the temperature patterns follow the Normal Distribution. Then the Hidden Markov model is designed that works on the Normal Distributed data to help in predicting the future temperature with some probability.

This application claims the benefit of Indian Patent Application Filing No. 671/CHE/2012, filed Feb. 23, 2012, which is hereby incorporated by reference in its entirety.

### FIELD OF THE INVENTION

The present invention relates generally to probabilistically predict temperature variation beyond an allowable limit in a server room from real time data acquisition, and in particular, to systems and methods for predicting abnormal temperature of a server room using Hidden Markov model.

### BACKGROUND

A server room can be modeled as rows of racks that house electronic systems, such as computing systems. The computing systems (such as computers, storage devices, networking devices, etc.) consume power for their operation. In addition, these computing systems disperse large amounts of heat during their operation. The computing systems can also affect the humidity, airflow, and other environmental conditions in the server room. In order to ensure proper operation of these systems, the computing systems need to be maintained within tight operating ranges of environmental conditions (e.g., temperature, pressure, humidity, and the like). The computing systems may need to be maintained within a desired temperature range, a desired humidity range, a desired air pressure range, and without the presence of moisture or fire. The failure to maintain such environmental conditions results in system failures.

Presently there are various technologies available to predict the server room temperature by analyzing the real time data. There is lot of research done on trends or behavior of server room's environment from real time continuously collected data through various sensors. Values measured by the sensors can be used to determine a change in operation levels of the environmental maintenance modules to keep the sensor values within a desired range. However, in the real time there is no model has been developed to predict probabilistically what will happen in the next moment. The existing technologies can't predict any abnormal temperature fluctuation at the last moment as they drive things from trends or behavior of temperature fluctuation over days which necessarily don't point to what will be the temperature at any server room at the last moment so that some preventive measures can be taken.

In view of the foregoing discussion, there is a need for predicting abnormal temperature fluctuation of the very next moment due to server heating or faulty behavior which does not depend on past data to predict something but does this in real time with much lesser computation than required to analyze the trend of past data.

### SUMMARY

The present invention solves the above mentioned problems by predicting the possibility of any abnormal rise or fall in temperature of the very next moment of the server room which gives the concerned people to take evasive actions.

According to the present embodiment, a method for predicting an abnormal temperature of a server room based on a Hidden Markov model is disclosed. In various embodiments of the present invention a plurality of temperature patterns of the server room follow a Normal distribution. The method includes capturing a current temperature and an immediate previous temperature of the server room through one or more sensors. Thereafter, a rate of change of temperature over a period of time of the server room is determined based on the current temperature and the immediate previous temperature. After that, by using the rate of change of temperature, a future temperature of the server room is predicted based on the Hidden Markov model. Subsequently, a probability of occurrence of the predicted future temperature is calculated based on a formulation of the Hidden Markov Model.

In an additional embodiment, a system for predicting an abnormal temperature of a server room based on a Hidden Markov model is disclosed. In various embodiments of the present invention a plurality of temperature patterns of the server room follow a Normal distribution. As disclosed, the system includes a temperature capturing module, a temperature change determination module, a future temperature prediction module and a probability calculation module. The temperature capturing module is configured to capture a current temperature and an immediate previous temperature of the server room through one or more sensors. The temperature change determination module is configured to determine a rate of change of temperature over a period of time of the server room based on the current temperature and the immediate previous temperature. The future temperature prediction module is configured to predict a future temperature of the server room based on the Hidden Markov model, wherein the future temperature is predicted using the rate of change of temperature. The probability calculation module is configured to calculate a probability of occurrence of the predicted future temperature by using a formulation of the Hidden Markov model.

In another embodiment, a computer program product for predicting an abnormal temperature of a server room based on a Hidden Markov model is disclosed. The computer program product includes a computer usable medium having a computer readable program code embodied therein for predicting an abnormal temperature of a server room based on a Hidden Markov model, wherein a plurality of temperature patterns of the server room follow a Normal distribution. The computer readable program code storing a set of instructions configured for capturing a current temperature and an immediate previous temperature of the server room through one or more sensors, determining a rate of change of temperature over a period of time of the server room based on the current temperature and the immediate previous temperature, predicting a future temperature of the server room based on the Hidden Markov model, wherein the future temperature is predicted using the rate of change of temperature and calculating a probability of occurrence of the predicted future temperature by using a formulation of the Hidden Markov model.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a block diagram illustrating a system for predicting an abnormal temperature of a server room based on a Hidden Markov model, in accordance with an embodiment of the present invention.

FIG. 3 is a flowchart, illustrating a method for predicting an abnormal temperature of a server room based on a Hidden Markov model, in accordance with an embodiment of the present invention.

FIG. 4 is an exemplary Standard Normal Distribution Curve for predicting an abnormal temperature of a server room based on a Hidden Markov model.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present disclosure provide a system and method for predicting an abnormal temperature of a server room based on a Hidden Markov model, where the real data collected by temperature sensors in server room is statistically analyzed and seen that the data follows a Gaussian (Normal) Distribution model. Hidden Markov model has been designed that works on sampled Gaussian distributed data to help in predicting with some probability the temperature at time (t+1) based on current temperature (t).

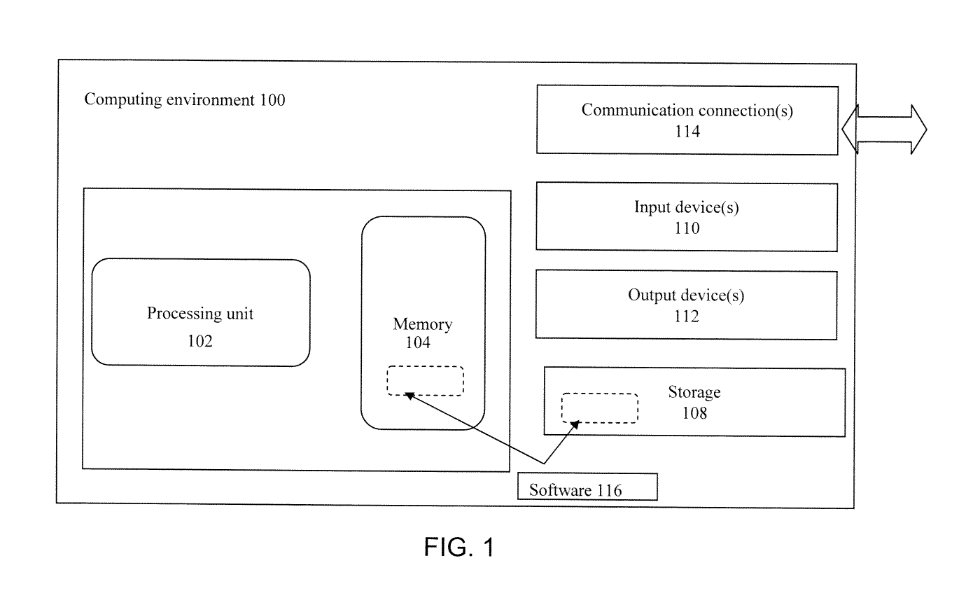

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can, for example, implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

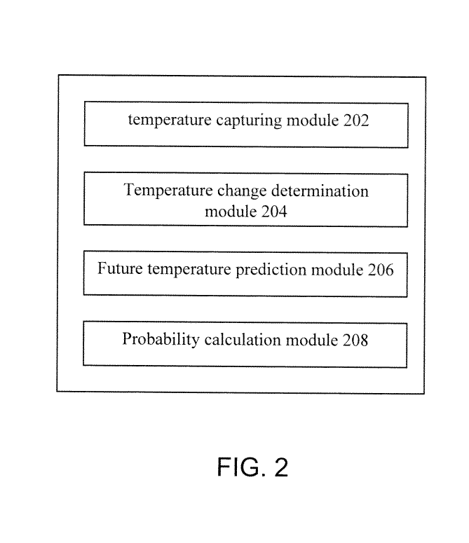

FIG. 2 is a block diagram illustrating a system for predicting an abnormal temperature of a server room based on a Hidden Markov model, in accordance with an embodiment of the present disclosure. More particularly, the system includes a temperature capturing module 202, a temperature change determination module 204, a future temperature prediction module 206 and a probability calculation module 208. In various embodiments of the present disclosure, the temperature capturing module 202 is configured to capture the server room temperature at any particular time through one or more sensors. The current rate of change of temperature of the server room is determined by the temperature change determination module 204. Based on the current rate of change of temperature a future temperature is predicted based on the Hidden Markov model using the future temperature prediction module 206. Again, by using a formulation of the Hidden Markov model the probability of reaching the predicted future temperature is calculated by the probability calculation module 208.

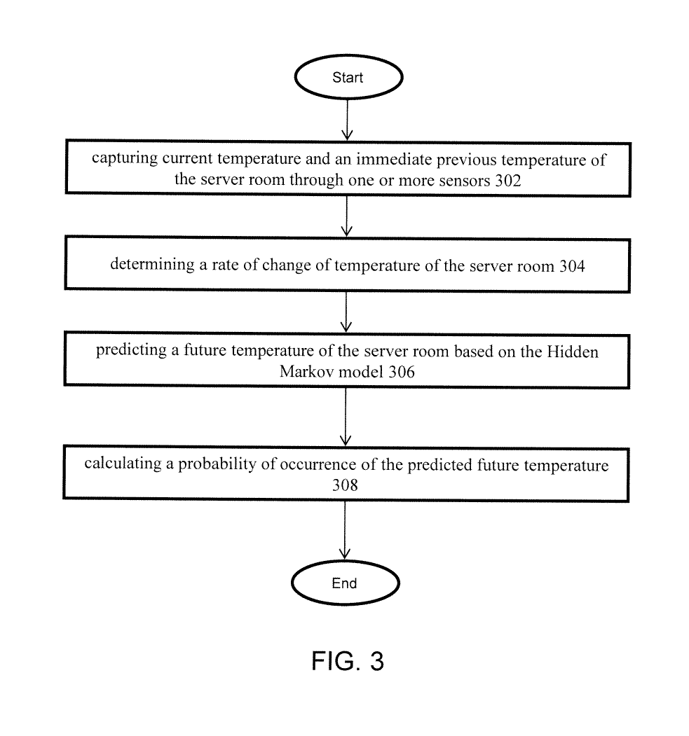

FIG. 3 is a flowchart, illustrating a method for predicting an abnormal temperature of a server room based on a Hidden Markov model, in accordance with an embodiment of the present disclosure. The method includes capturing a current temperature (xₜ) and an immediate previous temperature (xₜ₋₁) of the server room through one or more temperature sensors placed in the server room, as in block 302. The real time data captured by the one or more sensors placed on the racks of the server room are analyzed to develop a model to predict event. A Jarque-Bera test is performed to check if the null hypothesis that the data points are from a normal distribution holds. The observed p-value was 0:20 when the level of significance was set to 5 percent. In statistical significance testing, the p-value is the probability of obtaining a test statistic at least as extreme as the one that was actually observed, assuming that the null hypothesis is true. One often “rejects the null hypothesis” when the p-value is less than the significance level α (Greek alpha), which is often 0.05 or 0.1. When the null hypothesis is rejected, the result is said to be statistically significant. Since the observed p-value is more than 0:05, so the null hypothesis is accepted. Thus, the real time temperature patterns in the server room follow Normal or Gaussian distribution. In probability theory, the normal (or Gaussian) distribution is a continuous probability distribution that is often used as a first approximation to describe real-valued random variables that tend to cluster around a single mean value.

According to American Society of Heat, Refrigeration and Air Conditioning Engineers (ASHRAE) the normal range of server room monitoring is 20 degree Celsius to 25 degree Celsius. Based on this standard, that is not intended to limit the scope of this technique, the present disclosure defines the states of the Hidden Markov Model as Normal (temperature 20 degree Celsius to 25 degree Celsius), Freeze (below 20 degree Celsius) and Alarm (above 20 degree Celsius). These states are hidden as only rise or fall in absolute temperature is observed. Thus, the observables in Hidden Markov model are the rise and fall of the absolute temperature.

Referring back to FIG. 3, the rate of change of temperature of the server room is determined, as in block 304 and based on the current rate of change of temperature a future temperature is predicted based on the Hidden Markov model, as in block 306. Thereafter, the probability of reaching the predicted future temperature is calculated based on a formulation of the hidden Markov model, as in block 308. By predicting the future temperature, the future state of the Hidden Markov model is determined. To predict the transition between states of the Hidden Markov model the transition probabilities are determined.

### Calculating Transition Probabilities:

According to the Hidden Markov model the current state depends only on the past state. Thus, the temperature at time t can be represented as Xₜ and the temperature at time t−1 can be represented as Xₜ₋₁. If, Xₜ>Xₜ₋₁ and if the rate of increase of the temperature continues, then it is a chance to reach at Alarm state. In this case, the rate of increase can be calculated as follows:

Rate of increase =(Xₜ−Xₜ₋₁)/Xₜ₋₁

Then, if this rate continues, the value of a future temperature, say Xₜ₊₁, can be calculated as follows:

Future temperature (Xₜ₊₁)=Xₜ(1+(Xₜ−Xₜ₋₁)/Xₜ₋₁)

With respect to this predicted value the z value in the Normal Distribution curve is calculated as z=|Xₜ₊₁−μ|/σ, wherein μ is the mean of the normal distribution and σ represents standard deviation. A z value or z score is the statistical measure. A Z-Score tells how a single data point compares to normal data i.e. data this is found to follow normal distribution pattern. A Z-Score says not only whether a point was above or below average, but how unusual the measurement is.

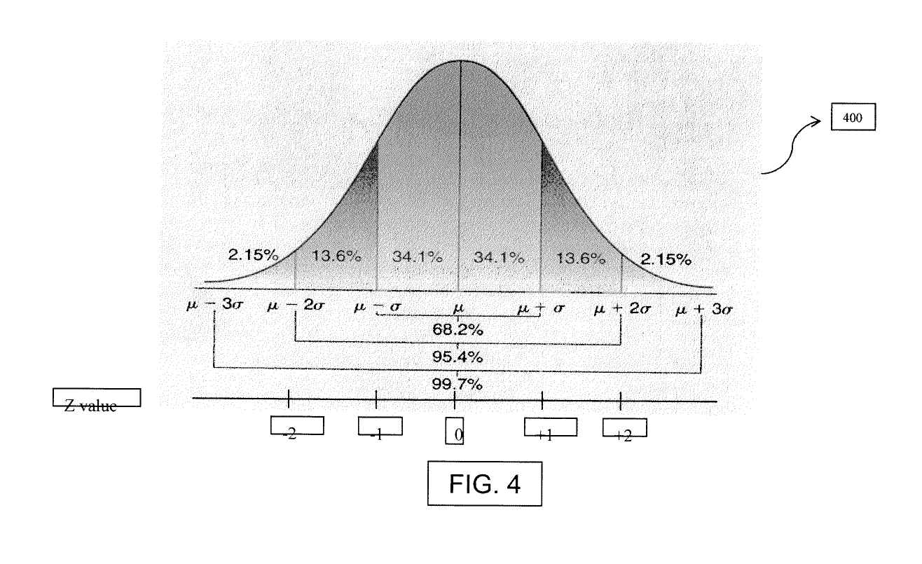

FIG. 4 is an exemplary Standard Normal Distribution Curve for predicting an abnormal temperature of a server room based on a Hidden Markov model. There is some percentage area under the curve corresponding to the z value of the curve and that represent the probability of a state to occur. For example, if z=1, then Xₜ₊₁=μ+σ in the Normal curve. From the curve it can be derived that the percentage area under the curve (z=−1 to +1) is 68.2%. Thus, the probability of occurring an Alarm state can be calculated as (1−0.682)=0.318, i.e. the possibility of transiting to Alarm state is 31.8%.

If Xₜ<Xₜ₋₁ and the rate of decrease continues then there is a chance of reaching Freeze state from the Normal state. The probabilistic transition to Freeze state also can be calculated based on the above mentioned process.

### Calculating Emission Probability:

By calculating emission probability it can be derived that whether the current temperature value (for example, Xₜ) will remain steady over a period of time or not. It can be described by using an example which does not intend to limit the scope of the disclosure and with the help of the exemplary Normal Distribution curve referred in FIG. 4. If, Xₜ=μ, then it is best likely to be in the known present state as the area under the Normal Distribution curve of FIG. 4 is 0 at μ. Thus, the probability would be 1. The z value of the Normal curve can be calculated as z=|Xₜ−μ|/σ. Corresponding to this z value there is some percentage (p) area under the curve, as calculated in earlier mentioned steps. Thus, the probability of remaining in the known present state can be calculated as (1−p).

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features.

Accordingly, the present invention is not intended to be limited to the embodiment shown but is to be accorded the widest scope consistent with the principles and features described herein.

We claim:

1. A computer implemented method executed by one or more computing devices for predicting an abnormal temperature of a server room based on a Hidden Markov model, wherein a plurality of temperature patterns of the server room follow a Normal distribution, comprising:
capturing a current temperature and an immediate previous temperature of the server room through one or more sensors;
determining a rate of change of temperature over a period of time of the server room based on the current temperature and the immediate previous temperature;
predicting a future temperature of the server room based on the Hidden Markov model, wherein the future temperature is predicted using the rate of change of temperature; and
calculating a probability of occurrence of the predicted future temperature using the Hidden Markov Model.

2. The method as claimed in claim 1, wherein the Markov model comprises of a Normal state, a Freeze state and an Alarm state.

3. The method as claimed in claim 2, wherein the Normal state, the Freeze state and the Alarm state are in hidden form.

4. The method as claimed in claim 2, wherein the Normal state ranges from 20° C. to 25° C., the Freeze state is below 20° C. and the Alarm state is above 25° C.

5. A system for predicting an abnormal temperature of a server room based on a Hidden Markov model, wherein a plurality of temperature patterns of the server room follow a Normal distribution, comprising:
a processor in operable communication with a processor readable storage medium, the processor readable storage medium containing one or more programming instructions whereby the processor is configured to implement:
a temperature capturing module configured to capture a current temperature and an immediate previous temperature of the server room through one or more sensors;
a temperature change determination module configured to determine a rate of change of temperature over a period of time of the server room based on the current temperature and the immediate previous temperature;
a future temperature prediction module configured to predict a future temperature of the server room based on the Hidden Markov model, wherein the future temperature is predicted using the rate of change of temperature; and
a probability calculation module configured to calculate a probability of occurrence of the predicted future temperature by using the Hidden Markov model.

6. The system as claimed in claim 5, wherein the Markov model comprises of a Normal state, a Freeze state and an Alarm state.

7. The system as claimed in claim 6, wherein the Normal state, the Freeze state and the Alarm state are in hidden form.

8. The system as claimed in claim 6, wherein the Normal state ranges from 20° C. to 25° C., the Freeze state is below 20° C. and the Alarm state is above 25° C.

9. A computer program product for use with a computer, the computer program product comprising a computer readable medium having computer readable program code embodied therein for predicting an abnormal temperature of a server room based on a Hidden Markov model, wherein a plurality of temperature patterns of the server room follow a Normal distribution, the computer readable program code storing a set of instructions configured for:
capturing a current temperature and an immediate previous temperature of the server room through one or more sensors;
determining a rate of change of temperature over a period of time of the server room based on the current temperature and the immediate previous temperature;
predicting a future temperature of the server room based on the Hidden Markov model, wherein the future temperature is predicted using the rate of change of temperature; and
calculating a probability of occurrence of the predicted future temperature by using the Hidden Markov model.

10. The computer program product as claimed in claim 9, wherein the Markov model comprises of a Normal state, a Freeze state and an Alarm state.

11. The computer program product as claimed in claim 10, wherein the Normal state, the Freeze state and the Alarm state are in hidden form.

12. The computer program product as claimed in claim 10, wherein the Normal state ranges from 20° C. to 25° C., the Freeze state is below 20° C. and the Alarm state is above 25° C.
